(19) United States
(12) Patent Application Publication
(10) Pub. No.: US 2023/0356630 A1
(43) Pub. Date: Nov. 9, 2023

(54) Seats Structure For Automotive Vehicle With 2, 3, or 4 Seats

(71) Applicants: Jean CELLE, Saint-Pierre-Eynac (FR); Sylvain RAVELEAU, Saint Just de Claix (FR); Christophe CELLE, Broomfield Midleton, Cork (IE); Ludovic CELLE, Oaxaca de Juarez (MX); Yann CELLE, Le Puy en Velay (FR)

(72) Inventors: Jean CELLE, Saint-Pierre-Eynac (FR); Sylvain RAVELEAU, Saint Just de Claix (FR); Christophe CELLE, Broomfield Midleton, Cork (IE); Ludovic CELLE, Oaxaca de Juarez (MX); Yann CELLE, Le Puy en Velay (FR)

(21) Appl. No.: 18/026,183

(22) PCT Filed: Sep. 22, 2021
(86) PCT No.: PCT/FR2021/051626

§ 371 Date: Mar. 14, 2023

(30) Foreign Application Priority Data
Sep. 24, 2020 (FR) FR2009742

(51) Int. Cl. B60N 2/01

(52) U.S. Cl. CPC B60N 2/01

(57) ABSTRACT

A structure of automotive vehicle seats receiving one driver seat and at least one passenger seat is presented. The driver seat and the at least one passenger seat are staggered and slotted with each other in the three dimensions.

### FIELD OF THE INVENTION

The following invention pertains to the technical domain of structures for automotive vehicle aimed at forming seats. More specifically, the structure according to the invention defines 2, 3, or 4 seats.

### BACKGROUND OF THE INVENTION

In urban settings, compact automotive vehicles have a notable success, due amongst other things to the traffic density, to the lack of parking space, and to the necessity to have energy-efficient automotive vehicles by the form of a lighter-weight automotive vehicle.

There are currently some automotive vehicles specifically dedicated to urban setting and carrying only the driver. The eventuality of a varied use to carry passengers and/or cargo, such as luggage, some merchandise or else some bulky items is regularly a criterion at the time for choosing the automotive vehicle to purchase. A compact vehicle with only two seats is sometimes unadapted.

Electric automobiles are a solution in terms of reducing the air pollution and sound pollution in urban settings. They are particularly adapted for the trips between home and workplace for a lot of drivers who use compact automobiles in mostly urban settings.

The electric traction system has the benefit of being reduced in space, which is key for the compact vehicles which cabin must accommodate several persons and/or a little luggage. It is very challenging to design a cabin space with such criteria in a very compact vehicle.

Furthermore, energy savings which are becoming increasingly necessary are favored by good aerodynamics, in particular for a vehicle to be potentially used on peri-urban motorways.

Moreover, compact automotive vehicles generally show poor ergonomies for the driver as the front wheel arch is taking space in the cabin. This applies bath to left-hand drive and right-hand drive automotive vehicles.

Therefore there is a need to create a more compact vehicle, less heavy, in order to decrease the energy consumption of such an automotive vehicle.

### SUMMARY OF THE INVENTION

One of the goals of the invention is therefore to offer a compact and light-weight structure of automotive vehicle cabin seats, in order to reduce the energy consumption of the vehicle.

Another goal of the invention is to provide such a structure at a reduced cost, and with an increased solidity, while improving the visual field for the driver.

Another goal of the invention is to provide an automotive vehicle that is more compact, lighter in weight, and with better aerodynamics.

To this effect, an automotive vehicle seats structure has been elaborated, which defines one driver seat and at least one passenger seat.

As per the invention, the driver seat and the at least one passenger seat are staggered and slotted with regard to each other in the three dimensions.

It is intended with “in the three dimensions” the fact that the driver seat and the passenger seat are staggered in height, width, and length. In other words, the seats are arranged following the x, y, and z axis of an orthonormal representation.

In this fashion, the vertical stagger of the seats structures allows the seats to be placed more tightly by slotting them with each other, in other words by letting them overlap slightly, which gives a more compact volume to the structure, which in turn makes the vehicle less heavy and therefore reduces its energy consumption.

Of course, such a structure allows the driver, in an urban setting, to find parking space more easily.

Asper a specific form of design, the driver seat is elevated in relation to the at least one passenger seat.

This positioning of the driver seat allows for a front visibility on a longer distance, in particular on roads with changing declivity, and allows for a better lateral visibility as well.

As per a specific form of design, the structure defines two passenger seats staggered and slotted in respect of the driver seat in the three dimensions.

Preferably, both passenger seats are aligned in height and in length.

As per another form of design, the structure defines three passenger seats, of which a first passenger seat aligned in height and in length with respect to the driver seat.

Moreover, a second passenger seat and a third passenger seat are staggered with respect to the driver seat and to the first passenger seat in the three dimensions, and the aforementioned second and third passenger seats are aligned one with the other in height and in length, the second and third passenger seats are slotted into the driver seat and to the first passenger seat respectively.

As per another form of design, the structure defines three passenger seats, of which a first passenger seat aligned in height and staggered backwards with respect to the driver seat. Moreover, a second passenger seat and a third passenger seat are staggered in relation to the driver seat and to the first passenger seat in the three dimensions, and the aforementioned second and third passenger seats are aligned one with the other in height and in length, the first passenger seat and the second passenger seat being slotted into the driver seat, and the third passenger seat being slotted into the first passenger seat.

As per an additional form of design, the structure defines three passenger seats, the driver seat and the three passenger seats being all staggered in respect of each other in the three dimensions, the first passenger seat and the second passenger seat being slotted into the driver seat, and the third passenger seat being slotted into the first passenger seat.

Preferably, the structure according to the invention comprises pillars meant to be extended up to a roof of the automotive vehicle and resting against each seat structure.

This way, the pillars contribute to improving the rigidity of the structure, in particular by avoiding crushing, which allows for a better safety for passengers.

As per a preferred form of design, the structure comprises frameworks defining the seats, and these frameworks comprise lateral and transverse panels which delimit a footrest area, a seating area, a back rest area and a head rest area.

This way, such frameworks allow for an increased protection of passengers.

The invention also pertains to an automotive vehicle comprising a structure such as mentioned above.

As per a specific form of design, the vehicle comprises powered wheels. In other words they contain an electric engine.

Preferably, the wheels on one side of the vehicle are staggered longitudinally in respect of the wheels on another side of the vehicle in order to improve comfort when driving over speed reduction ramps.

### BRIEF DESCRIPTION OF THE DRAWINGS

Further advantages and features will be more obvious in the following description, given as a non-limitative example of the invention concept, from the attached drawings in which:

FIG. 1 is a perspective view from above of the automotive vehicle structure showing the integration of the driver seat and the passenger seat according to the invention.

FIG. 2 is a similar view to FIG. 1, showing the structure from the side.

FIG. 3 is a similar view to FIG. 1, showing the structure from the front.

FIG. 4 is a view of the structure from above as per a form of design comprising two passenger seats.

FIG. 5 is a similar view to FIG. 4, showing the structure in perspective.

FIG. 6 is a similar view to FIG. 4, showing the structure from the front.

FIG. 7 is a similar view to FIG. 4, showing the structure from the rear.

FIG. 8 is a similar view to FIG. 4, showing the structure from the side.

FIG. 9 is a view of the structure from above as per a form of design comprising three passenger seats.

FIG. 10 is a similar view to FIG. 9, showing the structure in perspective.

FIG. 11 is a similar view to FIG. 9, showing the structure from the front.

FIG. 12 is a view of the structure from above as per another form of design comprising three passenger seats.

FIG. 13 is a similar view to FIG. 12, showing the structure in perspective.

FIG. 14 is a similar view to FIG. 12, showing the structure from the front.

FIG. 15 is a view of the structure from above as per another form of design comprising three passenger seats.

FIG. 16 is a similar view to FIG. 15, showing the structure in perspective.

FIG. 17 is a similar view to FIG. 15, showing the structure from the front.

### DETAILED DESCRIPTION OF THE INVENTION

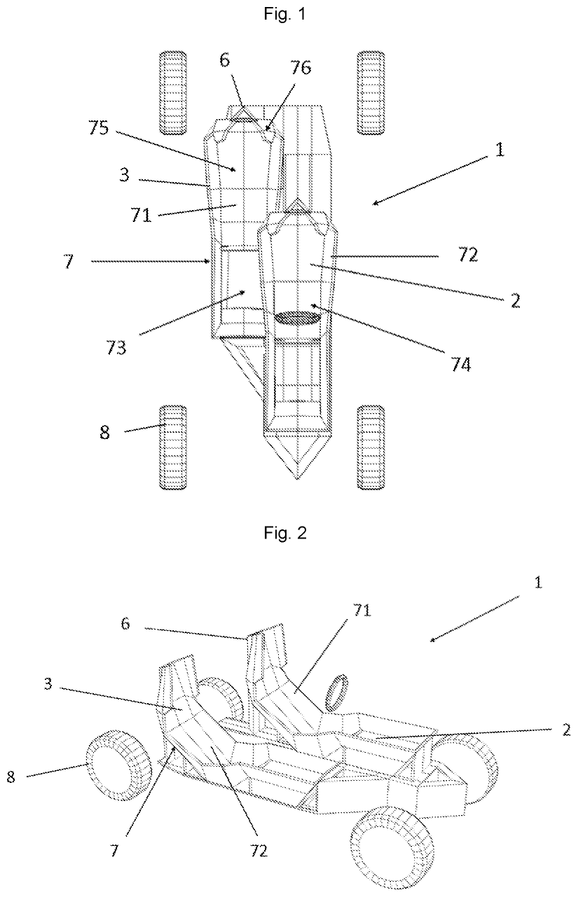

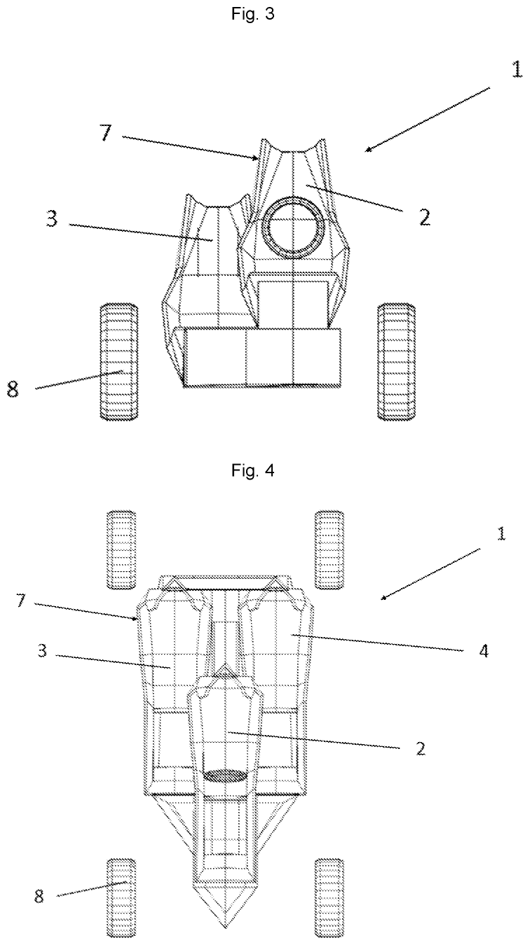

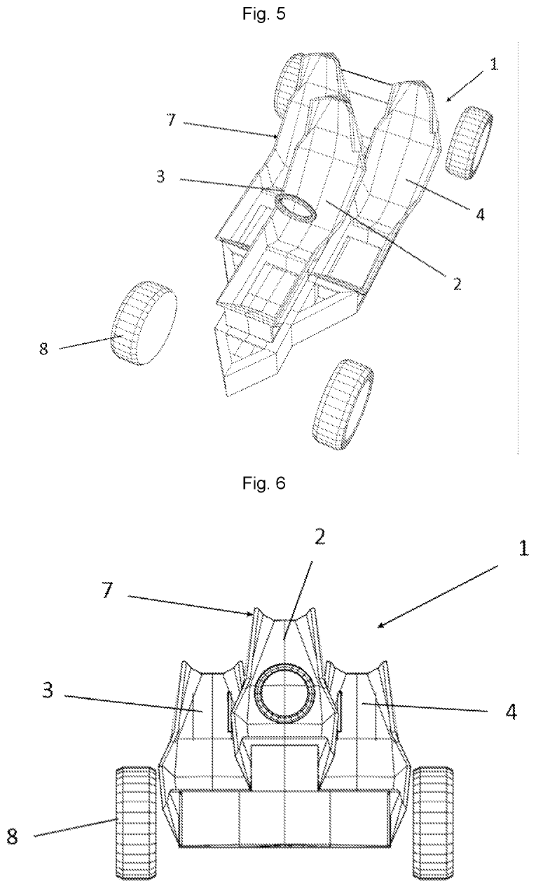

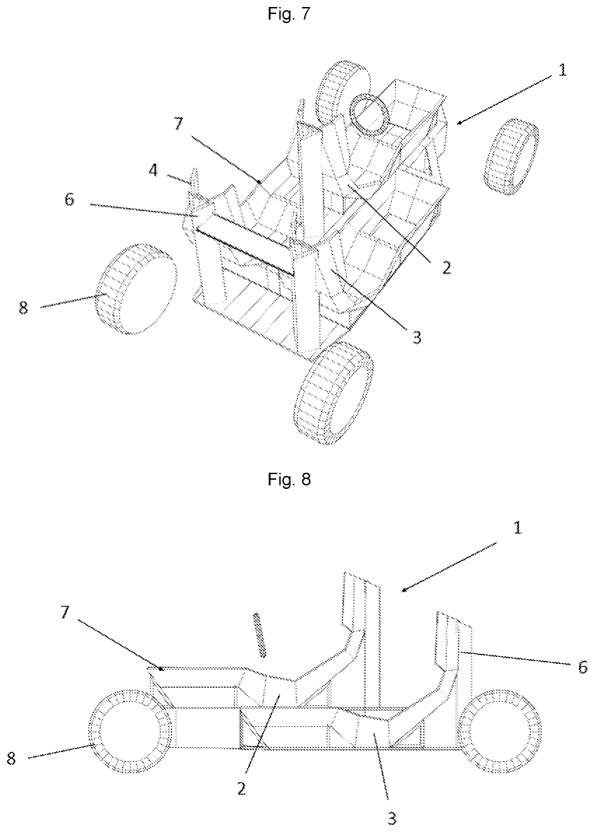

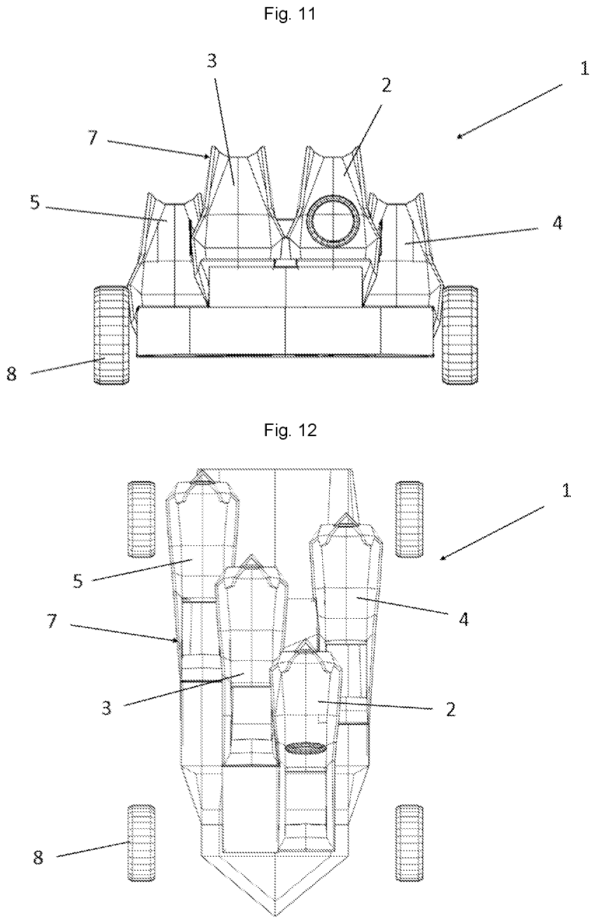

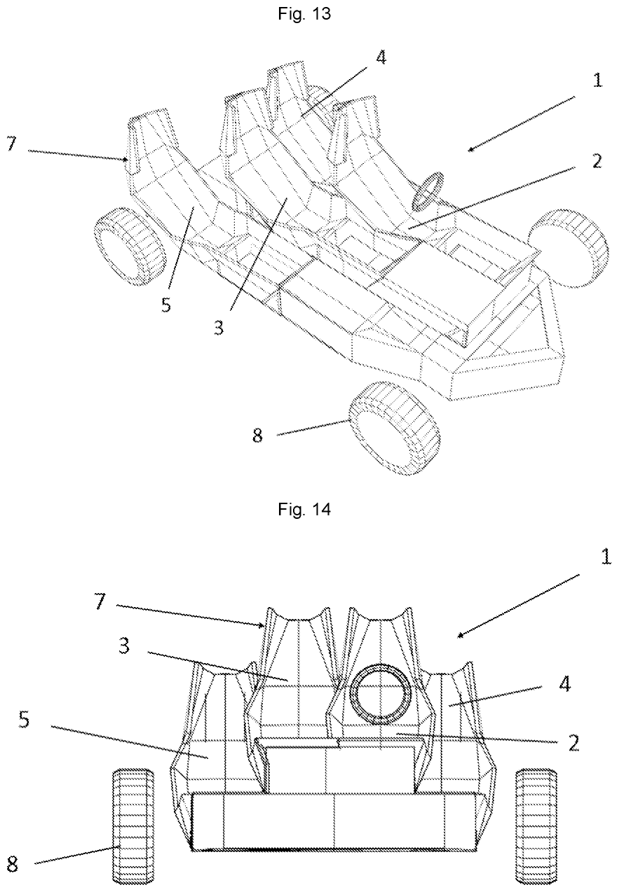

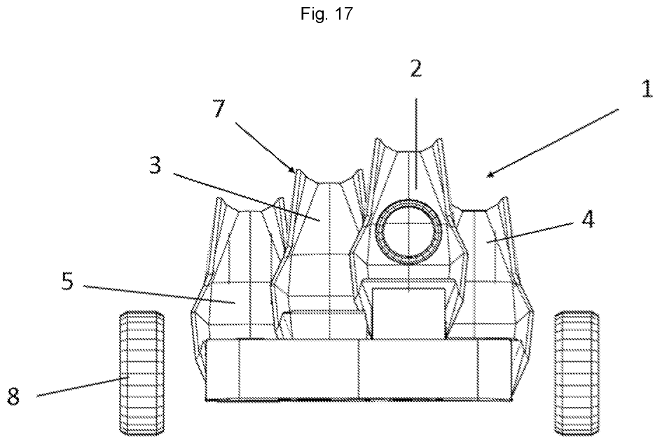

In relation to FIGS. 1 to 17, the present invention pertains to a structure (1) of automotive vehicle seats defining one driver seat (2) and at least one passenger seat (3), of which the driver (2) and passenger (3) seats are staggered and slotted with each other in the three dimensions.

The invention aims in particular to reduce the volume of the vehicle using the structure (1) as described further, while improving the safety of its occupants.

The present invention is a structure (1) for automobile with 2, 3 or 4 seats, defined by the position of seats staggered and slotted in the three dimensions, in other words, length, width and height. The vertical stagger of the seats structures (1) allows for a tighter placement of the seats and gives to the structure (1) of the cabin designed in this way, a more compact volume.

In order to maximize the benefits of such a structure (1), from the standpoint of mass, solidity, occupant safety, the seats comprising pillars (6) reaching up to the roof are an integral part of it. Occupant spaces are divided by longitudinal axis crossed with strengthening transversal bars, which contributes to a structure (1) that is rigid and protective for occupants.

As for the driver, he has the option to adjust the steering wheel, the manual commands, and the pedals, but possibly the driver seat structure could be adjustable.

The structure (1) comprises frameworks (7) defining the seats, and these frameworks comprise lateral (71) and transverse (72) panels which delimiting a footrest area (73), a seating area (74), a back rest area (75) and a head rest area (76). The frameworks are aimed at receiving the seat upholstery.

For a two seater car, see FIGS. 1 to 3, the driver's location is staggered in height, longitudinally and laterally in respect to the passenger seat (3). Depending if it's for a country with right-hand drive or left-hand drive, the driver area (2) is staggered towards the left or the right.

Therefore the structure (1) defines a passenger seat staggered in respect of the driver seat (2) in the three dimensions.

For a three seater car, see FIGS. 4 to 8, the central driver seat (2) is staggered in height and longitudinally with respect to the passenger seats (3,4), on the right and left, which are partially staggered under the driver seat (2). This structure (1) with 3 seats is suitable to right-hand driving as well as left-hand driving.

The structure (1) defines in this manner two passenger seats (3,4) staggered with respect to the driver seat (2) in the three dimensions, the aforementioned passenger seats (3,4) being aligned in height and length.

For a 4 seater car, there are 3 possible options.

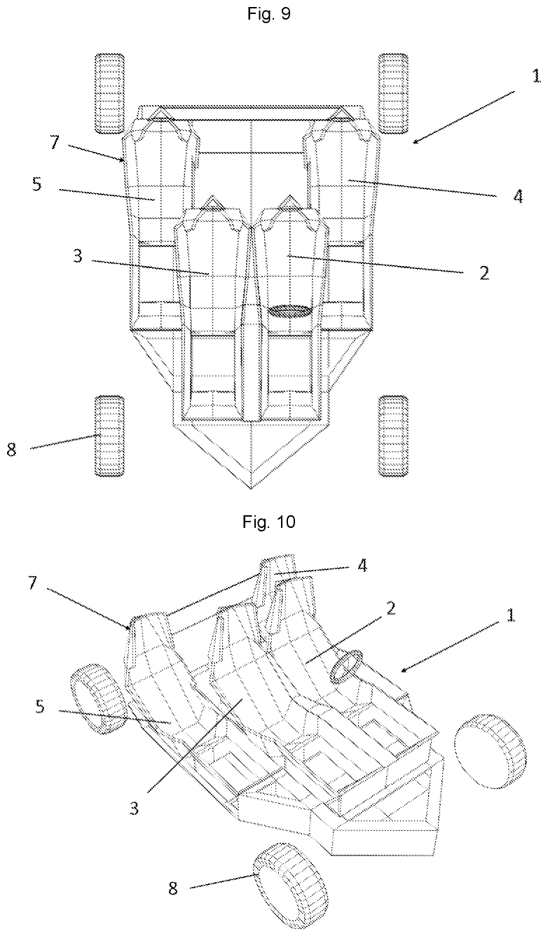

A first option, see FIGS. 9 to 11 with two seats (2,3) on the front side by side, the rear seats structures (4,5) being staggered in the three dimensions with respect to the front seats structure block (2,3). This right-left symmetrical version allows for adaptation of the driver space depending on the country on the right or on the left. This structure (1) is the option with the greatest width and the shortest length out of the 3 options with 4 seats.

A second option of design allows the structure (1) to define three passenger seats (3,4,5) of which one passenger seat (3) is aligned in height and staggered backwards with respect to the driver seat (2). Moreover, a second passenger seat (4) and a third passenger seat (5) are staggered with respect to the driver seat (2) and to the first passenger seat (3) in the three dimensions, and the aforementioned second (4) and third (5) passenger seats are aligned with each other in height and longitudinally.

This design, see FIGS. 12 to 14 with structures (1) for the two front seats (2,3), on the same vertical plane, and the front passenger seat's structure (3) staggered laterally and longitudinally backwards with respect to the driver seat (2), so as to reduce the width of the front seats space. The rear seats' structures (4,5) are staggered in the three dimensions with respect to the front seats' structures (2,3). This asymmetrical version leads to the design of structures (1) that are different depending on the countries with right- or left-hand drive.

This type of design of the structure (1) with 4 seats allows to define three passenger seats (3,4,5), of which a first passenger seat (3) is aligned in height with respect to the driver seat (2). Furthermore, a second passenger seat (4) and a third passenger seat (5) are staggered with respect to the driver seat (2) and to the first passenger seat (3) in the three dimensions, and the aforementioned second (4) and third passenger seats (5) are aligned one with the other in height and longitudinally.

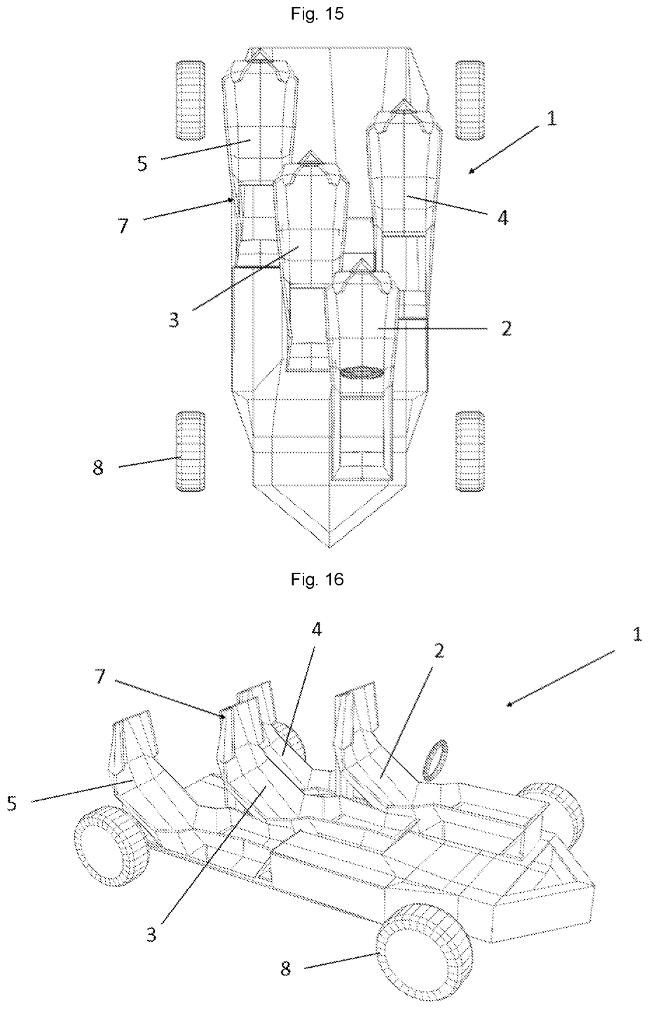

A third option is illustrated in FIGS. 15 to 17 with a stagger in the 3 dimensions of all the occupants structures. Compared to the 3-seater version, the fourth seat (5) is added on the right-hand side for the left-hand drive vehicles, or on the left-hand side for the right-hand drive vehicles. The increased longitudinal stagger between seats structures allows for a reduction of their vertical stagger. This asymmetrical structure (1) for 4 seats has the most reduced possible width out of the 3 options with 4 seats, thanks to the lateral slotting of all the adjacent seats.

This latter type of design of the structure (1) allows to define three passenger seats (3,4,5), the driver seat (2) and the three passenger seats (3,4,5) are all staggered between each other in the three dimensions.

The structure according to the invention allows the creation of a more compact cabin thanks to the vertical, lateral and longitudinal slotting together of seats' structures, for a reduced volume compared to current automobiles, and of which the arrangement between and around the seats, as integral part of the structure (1), provides a better solidity, with a mass and a moment of inertia that are reduced further.

The raised position of the driver gives the latter a forward visibility on a longer distance on roads with changing declivity and his position further to the front gives him an optimal lateral visibility, for improved safety conditions.

The central position of front seats, further away from the sides than in a conventional structure, puts them in a better protected position in the event of a side impact. For the rear passengers, a forward visibility coupled with a lot of space to stretch their legs allow for better comfort.

This type of structure (1) allows to be fitted with a body of which the SCx, in other words the drag coefficient multiplied by the front surface exposed to the air, is minimal, for a very good energy efficiency.

In the asymmetrical 4-seater versions, and possibly in the other structures (1), right and left wheels can be slightly staggered instead of having the same axis, which allows for improved comfort when driving over speed reduction ramps.

In the case of a heat engine car, the fuel tank will be ideally located in the center of the structure (1), in a very safe place in case of accident and in the case of an electric car, the center of the structure (1) can host in a very safe central space, the batteries, of significant weight, in central position for a reduced moment of inertia.

The engine can be positioned either at the front, or at the rear, or in the wheels (8).

The design of such a structure (1) could have variants in terms of cabin space depending on the body size of its usual occupants, depending on the populations considered in order to optimize the cars weight and the SCx, and depending on the automobile's road or urban or mixed use in order to maximize its energy efficiency.

For a structure (1) aimed at urban use, the seating area of the seats will be higher, the back rest more vertical, which will result in a shorter cabin, a taller but shorter automobile, which is an advantage in the city for parking.

Thus, for an electric car, the structure (1) is more compact, more rigid, more aerodynamical. With a lesser need for engine power, the vehicle can comprise a lighter and smaller electric engine, which leads to a lowered energy consumption, allowing for the use of a lighter and more compact set of batteries, and therefore of a chassis structure even more compact and lightweight.

This invention allows for a lesser need of raw material, energy and labor in the manufacturing process of this type of automotive structure (1) and therefore allows to reduce significantly the cost of production and the retail price in order to make the related vehicles, affordable to a wider number of users or of rent or car-pooling services. The running costs, amortization costs, and per-kilometer costs are reduced, which is an economic and ecological progress made possible by this type of structure (1).

In summary of the preceding description, the invention does provide a structure (1) that is lighter, more compact and with improved safety for the occupants, while reducing the cost of manufacturing of such a structure (1).

1. A seat structure for an automotive vehicle, defining a driver seat and at least one passenger seat, characterized in that the driver seat and the at least one passenger seat are staggered and slotted with each other in the-three dimensions.

2. The structure according to claim 1, characterized in that the driver seat is raised with respect to the at least one passenger seat.

3. The structure according to claim 1, characterized in that the structure defines two passenger seats staggered and slotted with respect to the driver seat in the three dimensions.

4. The structure according to claim 3, characterized in that the two passenger seats are aligned in height and longitudinally.

5. The structure according to claim 1, characterized in that the structure defines three passenger seats of which:
a first passenger seat is aligned in height and longitudinally with respect to the driver seat;
a second passenger seat and a third passenger seat, are staggered with respect to the driver seat and to the first passenger seat in the three dimensions, the second and third passenger seats are aligned with each other in height and longitudinally, and the second and third passenger seats are slotted in respect of the driver seat and the first passenger seat respectively.

6. The structure according to claim 1, characterized in that the structure defines three passenger seats, of which:
a first passenger seat is aligned in height and staggered backwards with respect to the driver seat;
a second passenger seat and a third passenger seat, are staggered with respect to the driver seat and to the first passenger seat in the three dimensions, the second and third passenger seats are aligned with each other in height and longitudinally, the first passenger seat and the second passenger seat being slotted into the driver seat, and the third passenger seat being slotted into the first passenger seat.

7. The structure according to claim 1, characterized in that the structure defines three passenger seats, the driver seat and the three passenger seats being all staggered with each other in the three dimensions, the first passenger seat and the second passenger seat being slotted into the driver seat, and the third passenger seat being slotted into the first passenger seat.

8. The structure according to claim 1, comprising pillars adapted to reach up to a roof of the automotive vehicle and resting against a back of each seat structure.

9. The structure according to claim 1, comprising frameworks defining the seats, and said frameworks comprising lateral and transverse panels delimiting:
a footrest area;
a seating area;
a back rest area; and
a head rest area.

10. An automotive vehicle comprising a structure according to claim 1,

11. The vehicle in according to claim 10, comprising powered wheels.

12. The vehicle in according to claim 11, characterized in that the wheels located on one side of the vehicle are staggered longitudinally with respect to the wheels located on another side of the vehicle.
